(19) United States
(12) Patent Application Publication
(10) Pub. No.: US 2024/0177521 A1
(43) Pub. Date: May 30, 2024

(54) MONITORING SYSTEM AND MONITORING METHOD

(71) Applicant: DeCloak Intelligences Co., Taipei City (TW)

(72) Inventor: Yao-Tung Tsou, Taipei City (TW)

(73) Assignee: DeCloak Intelligences Co., Taipei City (TW)

(21) Appl. No.: 18/508,198

(22) Filed: Nov. 13, 2023

Related U.S. Application Data
(60) Provisional application No. 63/425,274, filed on Nov. 14, 2022.
(60) Provisional application No. 63/536,080, filed on Sep. 1, 2023.

(51) Int. Cl. G06V 40/16

(52) U.S. Cl. CPC G06V 40/172

(57) ABSTRACT

A monitoring system and a monitoring method are provided by the disclosure. The monitoring method includes: capturing an image; obtaining a facial image of a monitoring target from the image; performing a de-identification processing on the image to obtain a de-identification image, and outputting the de-identification image; performing a first de-identification operation on the facial image to generate a de-identification feature; and determining whether the de-identification feature matches a pre-stored feature in a feature database to generate a verification result. In addition, the monitoring method further includes: performing a second de-identification operation on the facial image to generate a de-identification label; and querying an image database according to the de-identification label to obtain a historical de-identification image corresponding to the de-identification label.

### CROSS-REFERENCE TO RELATED APPLICATION

This application claims the priority benefit of U.S. provisional application Ser. No. 63/425,274, filed on Nov. 14, 2022, and U.S. provisional application Ser. No. 63/536,080, filed on Sep. 1, 2023. The entirety of each of the above-mentioned patent applications is hereby incorporated by reference herein and made a part of this specification.

### TECHNICAL FIELD

The disclosure relates to a monitoring system and a monitoring method.

### DESCRIPTION OF RELATED ART

With the popularization of monitors and the advancement of image identification technology, existing monitoring systems can almost completely grasp the whereabouts of monitoring targets and can store relevant image data of the monitoring targets for query. However, the technology seriously infringes on the privacy of people. In addition, when the stored image data is leaked, identity information of personnel in the image data is also exposed, thereby affecting the personal safety of the personnel. Therefore, how to protect the privacy of the personnel while preserving the monitoring image data is one of the important issues in the art.

### SUMMARY

The disclosure provides a monitoring system and a monitoring method, which can protect privacy of a monitoring target.

A monitoring system of the disclosure includes an image capturing device and a processing device. The image capturing device captures an image. The processing device is communicatively connected to the image capturing device and is configured to obtain a facial image of a monitoring target from the image; perform a de-identification processing on the image to obtain a de-identification image, and output the de-identification image; perform a first de-identification operation on the facial image to generate a de-identification feature; and determine whether the de-identification feature matches a pre-stored feature in a feature database to generate a verification result.

In an embodiment of the disclosure, the processing device is further configured to perform a second de-identification operation on the facial image to generate a de-identification label, and establish a mapping relationship between the de-identification label and the de-identification image to establish or update an image database.

In an embodiment of the disclosure, the second de-identification operation is the same as the first de-identification operation.

In an embodiment of the disclosure, the second de-identification operation is different from the first de-identification operation. The processing device performs the first de-identification operation based on a differential privacy algorithm and performs the second de-identification operation based on a homomorphic encryption algorithm.

In an embodiment of the disclosure, the de-identification processing includes covering the monitoring target in the image using a deep learning model to generate the de-identification image.

In an embodiment of the disclosure, the processing device is further configured to capture the facial image from the image using the deep learning model.

In an embodiment of the disclosure, the deep learning model includes a deep neural network.

In an embodiment of the disclosure, the processing device is further configured to perform a second de-identification operation on the facial image to generate a de-identification label; and query the image database according to the de-identification label to obtain the historical de-identification image corresponding to the de-identification label.

In an embodiment of the disclosure, the processing device is further configured to perform a fuzzy search on the image database according to the de-identification label to obtain the historical de-identification image.

In an embodiment of the disclosure, the processing device is further configured to determine whether the verification result is successful; and in response to the verification result being successful, query the image database according to the de-identification label to obtain the historical de-identification image corresponding to the de-identification label.

A monitoring method of the disclosure includes capturing an image; obtaining a facial image of a monitoring target from the image; performing a de-identification processing on the image to obtain a de-identification image, and outputting the de-identification image; performing a first de-identification operation on the facial image to generate a de-identification feature; and determining whether the de-identification feature matches a pre-stored feature in a feature database to generate a verification result.

In an embodiment of the disclosure, the monitoring method further includes performing a second de-identification operation on the facial image to generate a de-identification label; and establishing a mapping relationship between the de-identification label and the de-identification image to establish or update an image database.

In an embodiment of the disclosure, the second de-identification operation is the same as the first de-identification operation.

In an embodiment of the disclosure, the second de-identification operation is different from the first de-identification operation, the first de-identification operation is performed based on a differential privacy algorithm, and the second de-identification operation is performed based on a homomorphic encryption algorithm.

In an embodiment of the disclosure, the step of performing the de-identification processing on the image to obtain the de-identification image includes covering the monitoring target in the image using a deep learning model to generate the de-identification image.

In an embodiment of the disclosure, the step of obtaining the facial image of the monitoring target from the image includes capturing the facial image from the image using the deep learning model.

In an embodiment of the disclosure, the deep learning model includes a deep neural network.

In an embodiment of the disclosure, the monitoring method further includes performing a second de-identification operation on the facial image to generate a de-identification label; and querying an image database according to the de-identification label to obtain a historical de-identification image corresponding to the de-identification label.

In an embodiment of the disclosure, the step of querying the image database according to the de-identification label to obtain the historical de-identification image corresponding to the de-identification label includes performing a fuzzy search on the image database according to the de-identification label to obtain the historical de-identification image.

A monitoring system of the disclosure includes an image capturing device and a processing device. The image capturing device captures an image. The processing device is communicatively connected to the image capturing device and is configured to obtain a facial image of a monitoring target from the image, and perform a de-identification operation on the facial image to generate a de-identification label; perform a de-identification processing on the image to obtain a de-identification image; establish a mapping relationship between the de-identification label and the de-identification image to establish or update an image database; and in response to receiving a query command matching the de-identification label, output the de-identification image stored in the image database.

Based on the above, the monitoring system of the disclosure can perform the de-identification processing on the image using the deep neural network to protect the privacy of personnel in the image. For the monitoring target in the image, the monitoring system can perform the de-identification operation on the facial image of the monitoring target to generate the de-identification feature for verifying the identity of the personnel or the de-identification label for establishing the image database. The monitoring system can compare the de-identification feature with the pre-stored feature in the feature database to determine the identity of the monitoring target. On the other hand, the monitoring system can establish or update the image database storing the de-identification image using the de-identification label. When a user intends to find the whereabouts of a specific target, the monitoring system can complete the tracking of the specific target through querying the image database without infringing on the privacy of any person.

### BRIEF DESCRIPTION OF THE DRAWINGS

FIG. 1 is a schematic diagram of a monitoring system according to an embodiment of the disclosure.

FIG. 2 is a schematic diagram of an identity verification process according to an embodiment of the disclosure.

FIG. 3 is a schematic diagram of an image data query process according to an embodiment of the disclosure.

FIG. 4 is a flowchart of a monitoring method according to an embodiment of the disclosure.

FIG. 5 is a flowchart of another monitoring method according to an embodiment of the disclosure.

### DESCRIPTION OF THE EMBODIMENTS

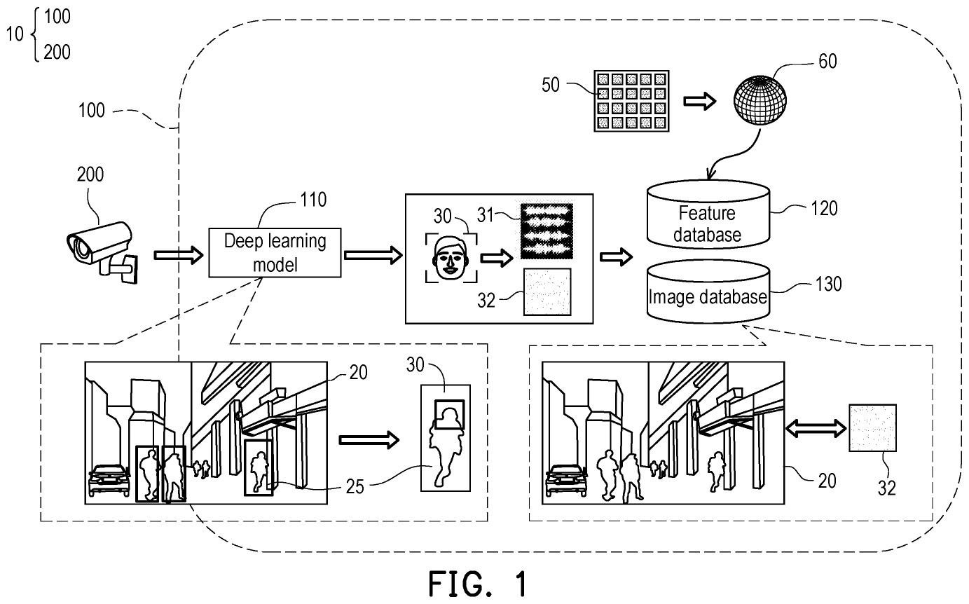

FIG. 1 is a schematic diagram of a monitoring system 10 according to an embodiment of the disclosure. The monitoring system 10 may include a processing device 100 and an image capturing device 200. In an embodiment, the processing device 100 and the image capturing device 200 are respectively implemented by different hardware devices, and the processing device 100 and the image capturing device 200 may communicate with each other. In an embodiment, the processing device 100 and the image capturing device 200 may be implemented by the same hardware device. For example, the processing device 100 may be an image signal processor (ISP) of the image capturing device 200.

The image capturing device 200 may include a charge coupled device (CCD), a complementary metal-oxide semiconductor (CMOS) element, or other types of photosensitive elements and may sense light intensity to generate an image of a photographic scene. The image capturing device 200 may also include a communication device supporting communication protocols such as wireless fidelity (Wi-Fi), radio frequency identification (RFID), Bluetooth, infrared, near-field communication (NFC), or device-to-device (D2D), an application programming interface (API), or a network connection device supporting Internet connection to perform communication or network connection with an external device or the processing device 100.

The processing device 100 is, for example, a server, a workstation, or other electronic devices. The processing device 100 may include a communication device, a storage device, and a processor. The communication device, for example, supports communication protocols such as wireless fidelity, radio frequency identification, Bluetooth, infrared, near field communication, or device-to-device, an application programming interface, or Internet connection to perform communication or network connection with the image capturing device 200 or an external device. The storage device is, for example, any type of fixed or removable random access memory (RAM), read-only memory (ROM), flash memory, hard disk, similar element, or a combination of the above elements to store a computer program executable by a processor. The processor is, for example, a central processing unit (CPU), other programmable general-purpose or specific-purpose microprocessors, microcontrollers, digital signal processors (DSPs), programmable controllers, application specific integrated circuits (ASICs), programmable logic devices (PLDs), other similar devices, or a combination of the devices. In an embodiment, the processor may load the computer program from the storage device to execute a monitoring method according to an embodiment of the disclosure.

The image capturing device 200 may capture an image. The processing device 100 may perform a de-identification processing on the image using a deep learning (DL) model 110 pre-stored in the processing device 100. Specifically, the processing device 100 may input the image to the deep learning model 110. The deep learning model 110 has an object detection function and may identify a monitoring target 25 in the input image. The deep learning model 110 may cover the monitoring target 25 in the image to generate a de-identification image 20. The processing device 100 may output the de-identification image 20 through, for example, a display for user reference. Since the monitoring target 25 in the de-identification image 20 has been covered, even if the de-identification image 20 shows the outline of the monitoring target 25, personnel viewing the de-identification image 20 still cannot identify the identity of the monitoring target 25. Therefore, the de-identification image 20 may protect the privacy of the monitoring target 25.

In an embodiment, the deep learning model 110 may include a deep neural network (DNN).

The deep learning model 110 may capture a facial image 30 of the monitoring target 25 from the input image. The processing device 100 may perform a de-identification operation on the facial image 30 to generate one or more de-identification features 31. The processing device 100 may, for example, determine whether the de-identification feature 31 matches a pre-stored feature in a feature space 60 in a feature database 120 using an artificial intelligence model to generate a verification result. The processing device 100 may perform the de-identification operation based on, for example, a differential privacy algorithm to take less time to generate the de-identification feature 31 or the processing device 100 may perform the de-identification operation based on other encryption algorithms (for example, a homomorphic encryption algorithm). If the de-identification feature 31 matches the pre-stored feature (for example, the similarity between the de-identification feature 31 and the pre-stored feature is greater than a threshold), it means that the identity of the monitoring target 25 is a specific person corresponding to the pre-stored feature. Accordingly, the processing device 100 may generate a successful verification result. If the de-identification feature 31 does not match any pre-stored feature (for example, the similarity between the de-identification feature 31 and the pre-stored feature is less than or equal to the threshold), it means that the identity of the monitoring target 25 is unknown. Accordingly, the processing device 100 may generate a failed verification result. After generating the verification result, the processing device 100 may output the verification result for user reference.

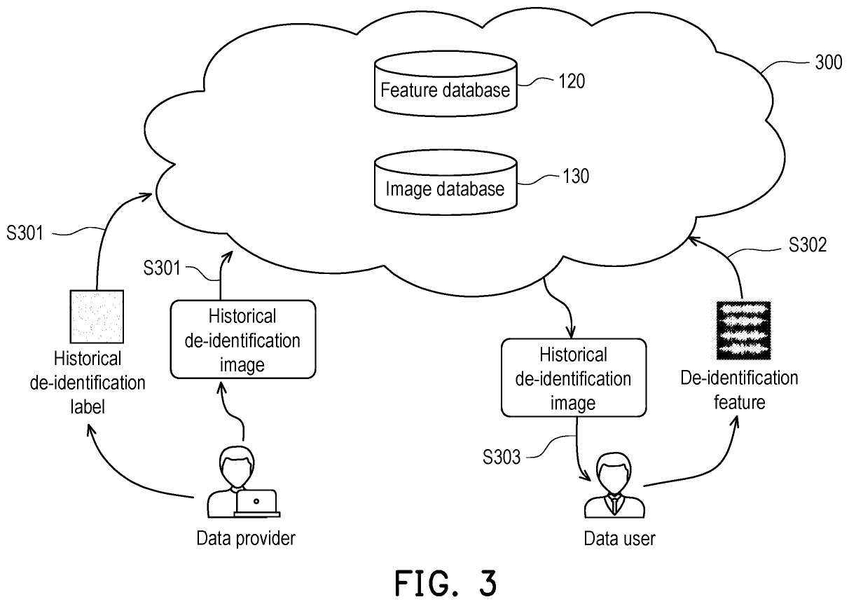

In order to establish the feature space 60 in the feature database 120, the processing device 100 may obtain multiple historical images of multiple personnel (for example, through the image capturing device 100). The processing device 100 performs the de-identification operation on the historical images according to the deep learning model 110 to generate multiple historical de-identification features 50. The processing device 100 may establish the feature space 60 according to the historical de-identification features 50. The feature space 60 may include one or more historical de-identification features corresponding to the identity of the specific person. The feature space 60 is obtained, for example, from an embedded space or a loss function, such as AdaFace, ArcFace, etc., which includes optimizing a margin of a geodesic distance through the correspondence between angles or radians in a normalized hypersphere. The feature database 120 may be stored in, for example, the processing device 100 or an external cloud server (for example, a cloud server 300 as shown in FIG. 3).

On the other hand, the processing device 100 may perform a de-identification operation on the facial image 30 to generate a de-identification label 32, wherein the de-identification operation for generating the de-identification label 32 and the de-identification operation for generating the de-identification feature 31 may be the same or different, that is, the de-identification label 32 and the de-identification feature 31 may be the same or different. In an embodiment, the processing device 100 may perform the de-identification operation for generating the de-identification label 32 based on, for example, the homomorphic encryption algorithm to generate the de-identification label 32 that is easier to identify or the processing device 100 may perform the de-identification operation based on other encryption algorithms (for example, the differential privacy algorithm). In an embodiment, the processing device 100 may perform the de-identification operation based on the homomorphic encryption algorithm based on post-quantum-secure de-identification.

In an embodiment, after generating the de-identification label 32, the processing device 100 may establish or update the image database 130 using the de-identification label 32. Specifically, the processing device 100 may establish a mapping relationship between the de-identification label 32 and the de-identification image 20, thereby establishing or updating the image database 130, wherein the image database 130 may store the de-identification label 32, the de-identification image 20, and the mapping relationship between the two. The image database 130 may be stored in, for example, the processing device 100 or an external cloud server (for example, the cloud server 300 as shown in FIG. 3).

In an embodiment, after generating the de-identification label 32, the processing device 100 may query relevant image data of the monitoring target 25 using the de-identification label 32. Specifically, the image database 130 may pre-store a historical de-identification label and a historical de-identification image having a mapping relationship. The processing device 100 may query the image database 130 to determine whether the historical de-identification label matching the de-identification label 32 is stored. For example, the processor 100 may perform a fuzzy search on the image database 130 according to the de-identification label 32 to determine whether the image database 130 stores the historical de-identification label matching the de-identification label 32. If the de-identification label 32 matches the historical de-identification label in the image database 130 (for example, the similarity between the de-identification label 32 and the historical de-identification label is greater than a threshold), the processing device 100 may output the historical de-identification image corresponding to the historical de-identification label for user reference. If the de-identification label 32 does not match any historical de-identification label in the image database 130, it means that the image database 130 does not store any image data relevant to the monitoring target 25.

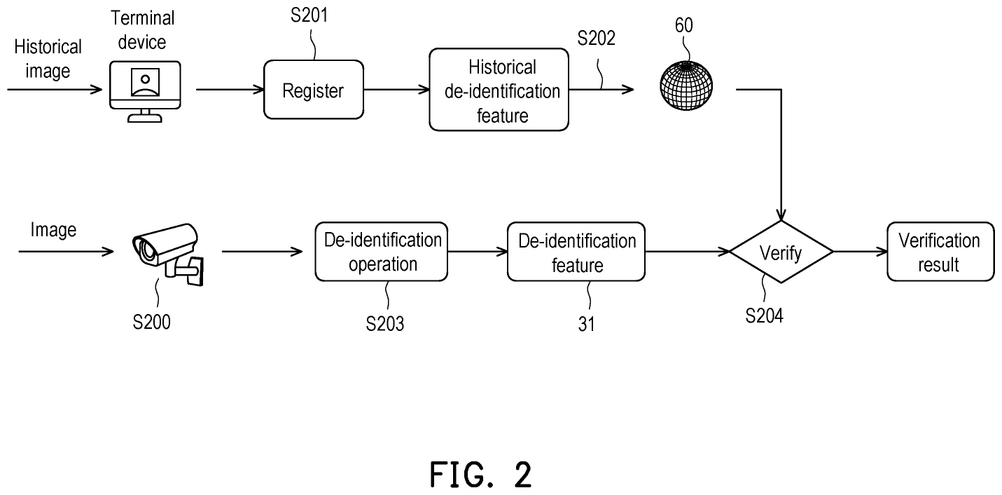

FIG. 2 is a schematic diagram of an identity verification process according to an embodiment of the disclosure. The monitoring system 100 may perform a registration process to establish the feature space 60. Specifically, the processing device 100 may be communicatively connected to an external terminal device. A data provider may transmit a historical image for registration to the processing device 100 through the terminal device, wherein the historical image may include an image of a specific target (for example, a person on a blacklist or a member of a shopping mall). In Step S201, the processing device 100 may execute the registration process. The processing device 100 may perform the de-identification operation (for example, the de-identification operation based on the differential privacy algorithm) on the historical image to obtain the one or more historical de-identification features. In Step S202, the processing device 100 may establish the feature space 60 including one or more pre-stored features according to the one or more historical de-identification features.

After completing the establishment of the feature space 60, the processing device 100 may perform identity verification according to the feature space 60. Specifically, the processing device 100 may obtain an image including the monitoring target 25 through the image capturing device 200. In Step S203, the processing device 100 may capture the facial image 30 of the monitoring target 25 from the image using the deep learning model 110, and perform the de-identification operation on the facial image 30 to generate the de-identification feature 31. In Step S204, the processing device 100 may compare the similarity between the de-identification feature 31 and the pre-stored feature in the feature space 60 to verify the identity of the monitoring target 25, thereby generating the verification result.

FIG. 3 is a schematic diagram of an image data query process according to an embodiment of the disclosure. In order to establish or update the image database 130 in the cloud server 300, in Step S301, a data provider may upload a historical de-identification label and a historical de-identification image having a mapping relationship into the image database 130 of the cloud server 300.

A data user (or the image capturing device 200) may send a query command including an image to the processing device 100. The processing device 100 may capture a facial image of a monitoring target from the image, and perform a de-identification operation on the facial image to obtain a de-identification feature and a de-identification label. In Step S302, the processing device 100 may access the feature database 120 in the cloud server 300 to determine whether a feature space stored in the feature database 120 includes a pre-stored feature matching the de-identification feature.

If the feature space includes the pre-stored feature matching the de-identification feature, it means that a verification result of the identity of the monitoring target is successful. Accordingly, the processing device 100 may further query whether the image database 130 stores the historical de-identification label matching the de-identification label. In response to the de-identification label matching the historical de-identification label in the image database 130, the processing device 100 may obtain the historical de-identification image corresponding to the historical de-identification label from the image database 130. In Step S303, the processing device 100 may output the historical de-identification image corresponding to the monitoring target for reference by the data user. Based on the above, the monitoring system 100 of the disclosure can first spend less time or computing resources to verify the identity of the monitoring target through the de-identification feature. After the identity of the monitoring target is verified, the monitoring system 100 then spends more time or computing resources to query the de-identification image associated with the monitoring target through the de-identification label.

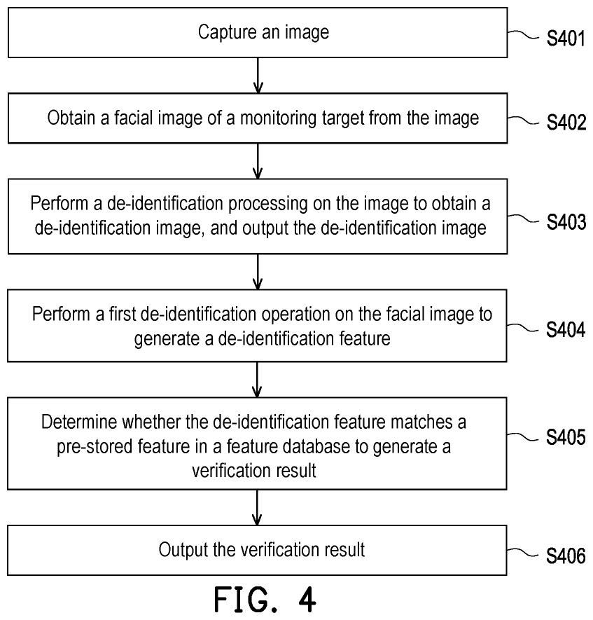

FIG. 4 is a flowchart of a monitoring method according to an embodiment of the disclosure, wherein the monitoring method may be implemented by the monitoring system 10 shown in FIG. 1. In Step S401, an image is captured. In Step S402, a facial image of a monitoring target is obtained from the image. In Step S403, a de-identification processing is performed on the image to obtain a de-identification image, and the de-identification image is output. In Step S404, a first de-identification operation is performed on the facial image to generate a de-identification feature. In Step S405, whether the de-identification feature matches a pre-stored feature in a feature database is determined to generate a verification result. In Step S406, the verification result is output.

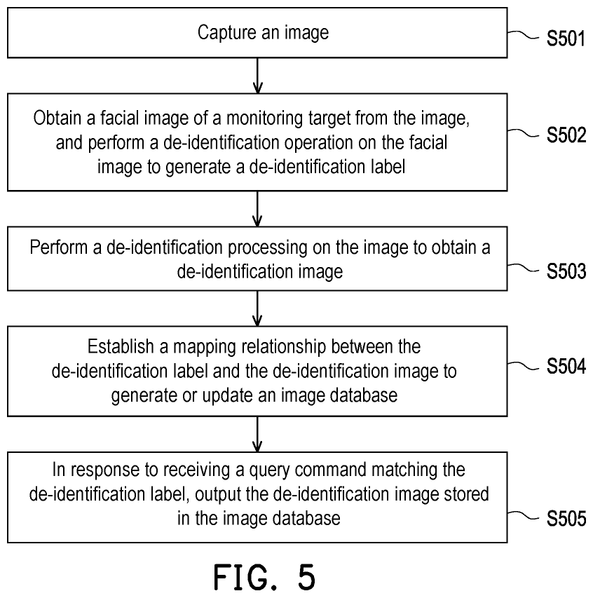

FIG. 5 is a flowchart of another monitoring method according to an embodiment of the disclosure, wherein the monitoring method may be implemented by the monitoring system 10 shown in FIG. 1. In Step S501, an image is captured. In Step S502, a facial image of a monitoring target is obtained from the image, and a de-identification operation is performed on the facial image to generate a de-identification label. In Step S503, a de-identification processing is performed on the image to obtain a de-identification image. In Step S504, a mapping relationship between the de-identification label and the de-identification image is established to establish or update an image database. In Step S505, in response to receiving a query command matching the de-identification label, the de-identification image stored in the image database is output.

In summary, the monitoring system of the disclosure adopts advanced technology to protect personal privacy while being able to observe and track suspicious activities in a targeted manner. The monitoring system uses the decentralized artificial intelligence model and the carefully designed differential privacy and homomorphic encryption technologies to track specific personnel without compromising their privacy. The advanced multi-modal deep neural network model based on the post-quantum-secure de-identification can ensure the high efficiency of the human image processing task and the high accuracy of the identification task, while achieving the de-identification of the image data. The monitoring system can be seamlessly integrated with the existing monitoring infrastructure to provide a powerful solution to the challenges of mass monitoring while maintaining personal privacy.

The monitoring system of the disclosure can have the following advantages. The monitoring system can be seamlessly integrated with the existing monitoring system through the application programming interface. The monitoring system can be highly compatible to support a cloud computing platform and an edge computing platform at the same time, thereby providing flexibility and scalability. The monitoring system can use the differential privacy and homomorphic encryption algorithms to implement powerful privacy protection and secure image search. The monitoring system can identify and track the specific target with extremely high accuracy.

What is claimed is:

1. A monitoring system, comprising:
an image capturing device, capturing an image; and
a processing device, communicatively connected to the image capturing device and configured to perform:
obtaining a facial image of a monitoring target from the image;
performing a de-identification processing on the image to obtain a de-identification image, and outputting the de-identification image;
performing a first de-identification operation on the facial image to generate a de-identification feature; and
determining whether the de-identification feature matches a pre-stored feature in a feature database to generate a verification result.

2. The monitoring system according to claim 1, wherein the processing device is further configured to perform:
performing a second de-identification operation on the facial image to generate a de-identification label, and establishing a mapping relationship between the de-identification label and the de-identification image to establish or update an image database.

3. The monitoring system according to claim 2, wherein the second de-identification operation is the same as the first de-identification operation.

4. The monitoring system according to claim 2, wherein the second de-identification operation is different from the first de-identification operation, wherein the processing device performs the first de-identification operation based on a differential privacy algorithm and performs the second de-identification operation based on a homomorphic encryption algorithm.

5. The monitoring system according to claim 1, wherein the de-identification processing on the image comprises:
covering the monitoring target in the image using a deep learning model to generate the de-identification image.

6. The monitoring system according to claim 5, wherein the processing device is further configured to perform:
capturing the facial image from the image using the deep learning model.

7. The monitoring system according to claim 5, wherein the deep learning model comprises a deep neural network.

8. The monitoring system according to claim 1, wherein the processing device is further configured to perform:
performing a second de-identification operation on the facial image to generate a de-identification label; and
querying an image database according to the de-identification label to obtain a historical de-identification image corresponding to the de-identification label.

9. The monitoring system according to claim 8, wherein the processing device is further configured to perform:
performing a fuzzy search on the image database according to the de-identification label to obtain the historical de-identification image.

10. The monitoring system according to claim 8, wherein the processing device is further configured to perform:
determining whether the verification result is successful; and
in response to the verification result being successful, querying the image database according to the de-identification label to obtain the historical de-identification image corresponding to the de-identification label.

11. A monitoring method, comprising:
capturing an image;
obtaining a facial image of a monitoring target from the image;
performing a de-identification processing on the image to obtain a de-identification image, and outputting the de-identification image;
performing a first de-identification operation on the facial image to generate a de-identification feature; and
determining whether the de-identification feature matches a pre-stored feature in a feature database to generate a verification result.

12. The monitoring method according to claim 11, further comprising:
performing a second de-identification operation on the facial image to generate a de-identification label; and
establishing a mapping relationship between the de-identification label and the de-identification image to establish or update an image database.

13. The monitoring method according to claim 12, wherein the second de-identification operation is the same as the first de-identification operation.

14. The monitoring method according to claim 12, wherein the second de-identification operation is different from the first de-identification operation, the first de-identification operation is performed based on a differential privacy algorithm, and the second de-identification operation is performed based on a homomorphic encryption algorithm.

15. The monitoring method according to claim 11, wherein the step of performing the de-identification processing on the image to obtain the de-identification image comprises:
covering the monitoring target in the image using a deep learning model to generate the de-identification image.

16. The monitoring method according to claim 15, wherein the step of obtaining the facial image of the monitoring target from the image comprises:
capturing the facial image from the image using the deep learning model.

17. The monitoring method according to claim 15, wherein the deep learning model comprises a deep neural network.

18. The monitoring method according to claim 11, further comprising:
performing a second de-identification operation on the facial image to generate a de-identification label; and
querying an image database according to the de-identification label to obtain a historical de-identification image corresponding to the de-identification label.

19. The monitoring method according to claim 18, wherein the step of querying the image database according to the de-identification label to obtain the historical de-identification image corresponding to the de-identification label comprises:
performing a fuzzy search on the image database according to the de-identification label to obtain the historical de-identification image.

20. A monitoring system, comprising:
an image capturing device, capturing an image; and
a processing device, communicatively connected to the image capturing device and configured to perform:
obtaining a facial image of a monitoring target from the image, and performing a de-identification operation on the facial image to generate a de-identification label;
performing a de-identification processing on the image to obtain a de-identification image;
establishing a mapping relationship between the de-identification label and the de-identification image to establish or update an image database; and
in response to receiving a query command matching the de-identification label, outputting the de-identification image stored in the image database.
